(19) United States
(12) Patent Application Publication
(10) Pub. No.: US 2005/0041163 A1
(43) Pub. Date: Feb. 24, 2005

(54) Stereoscopic television signal processing method, transmission system and viewer enhancements

(76) Inventors: Bernie Butler-Smith, Malibu Lake, CA (US); Steve Schklair, Altadena, CA (US)

Correspondence Address: BAKER & HOSTETLER LLP, Washington Square, Suite 1100, 1050 Connecticut Avenue, N.W., WASHINGTON, DC, 20036, US

(21) Appl. No.: 10/840,658

(22) Filed: May 7, 2004

Related U.S. Application Data
(60) Provisional application No. 60/468,260, filed on May 7, 2003.

(51) Int. Cl. H04N 5/64

(52) U.S. Cl. 348/744

(57) ABSTRACT

This invention provides a low cost method of enhancing a TV or projector which uses a Spatial Light Modulator and Color Wheel, to make a Stereoscopic TV or projector, by using polarizing material added to the color wheel, and using the synchronization of the color segments of the color wheel to synchronize the sequence of “left-eye” and “right-eye” views of the stereoscopic display. By using passive polarizing material (linear and/or circular polarization) on the color wheel, passive polarizing eyewear may also be used. Because a typical color wheel rotates a multiple of the video frame rate, a flicker-free stereoscopic display is realized.

### CROSS-REFERENCE TO RELATED APPLICATIONS

This application claims priority to and is a non-provisional of U.S. provisional patent application entitled, Stereoscopic 3D TV System: End-to-End Solution, filed May 7, 2003, having a Ser. No. 60/468,260, the disclosure of which is hereby incorporated by reference in its entirety.

### FIELD OF THE INVENTION

The present invention relates generally to a method used to combine dual streams of video into a standard single stream of video. More particularly, the present invention relates to a method of combining a dual stream of standard video, to occupy a single stream of standard video, providing a means to enhance a viewers experience in several ways.

### BACKGROUND OF THE INVENTION

A TV or projector based on a single-chip Spatial Light Modulator, such as a DMD (Digital Micromirror Device), typically uses a color wheel to render red, green and blue primary colors separately onto the screen, at a very fast-interleaved sequence. A color wheel is an -opto-mechanical assembly that contains colored arc segments mounted to a motor, which rotates at a specified speed, typically a multiple of the video frame-rate. White light is aimed at the color wheel, which causes red, green or blue light to be filtered through. These colors are then projected onto the DMD chip, which modulates the intensities for each pixel based on the brightness for each color, to be displayed on a screen. A typical color wheel rotates 4 to 6 times for every frame (or field) of video, so the viewer does not observe color sequencing; the brain integrates these sub-frames as a single full color image. Using a single Spatial Light Modulator, and a single source of white light, in combination with a color wheel, reduces the overall cost of a TV or projector.

A typical color wheel also has a multiple of RGB (Red, Green, Blue) segments, or RGB groups, to simplify different sub-frame rates being rendered.

There is various prior art covering various means to display stereoscopic imagery on a TV, including field sequential shuttering methods, dual projection methods, lenticular and other optical methods, and cross-polarized methods using electronically-controlled liquid-crystal polarizing filters.

While many of these methods perform with some limitation, such as cost, or the “shuttering” effect, this invention takes advantage of the existing capabilities of specific TVs and projectors, to produce a good quality stereoscopic display.

At the present time, TVs and projectors based on a Spatial Light Modulator, such as the DMD, have a longer operational life than other TV technologies, and it is hoped by the inventors of this application that the DMD will become the de facto standard for new TVs, which will enable them to be stereoscopic “3D-Capable” by this invention.

### SUMMARY OF THE INVENTION

This invention creates a Stereoscopic 3D display, consisting of a single screen, by adding a layer of polarizing material to the color wheel of a TV based on a Spatial Light Modulator, such as a DMD, and using the sub-frame renderings to perform a rapid “left-eye” and “right-eye” interleaving, at a rate higher than the video frame rate. The Spatial Light Modulator in conjunction with the color wheel creates a “shutter” for not only the primary-color sub-frames of each frame, but also to interleave the “left-eye” and “right-eye” sub-frames to be displayed on the screen. The color wheel can therefore be considered now a color/polarizing wheel.

The synchronization of the color segments of the color wheel are used to synchronize the sequence of “left-eye” and “right-eye” views of the stereoscopic display. Passive polarizing material (linear and/or circular polarization) is added as a layer to the color wheel, rendering polarized primary color sub-frames on the screen.

Passive polarized glasses are worn by the viewer of this screen, which separates the polarized light using polarized filters, so that each eye sees its respective “left-eye” and “right-eye” view.

A typical color wheel rotates a multiple of times per video frame, and has a multiple of RGB (Red, Green, Blue) segments, or RGB groups, therefore a flicker-free stereoscopic display is realized.

This invention takes advantage of existing prior art, and by the enhancements to these existing elements, creates a Stereoscopic 3D display.

The foregoing needs are met, to a great extent, by the present invention, wherein in one aspect an apparatus is provided that in some embodiments

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

For a better understanding of the present invention, reference is made to the following descriptions taken in conjunction with the accompanying drawings, in which, by example:

FIG. 1 shows a six-segment color wheel consisting of two red, two green, and two blue segments (i.e. two RGB groups).

FIG. 2 shows the red image created on the screen when the white light is passed through the red segments of the color wheel.

FIG. 3 shows the green image created on the screen when the white light is passed through the green segments of the color wheel.

FIG. 4 shows the blue image created on the screen when the white light is passed through the blue segments of the color wheel.

FIG. 5 shows what the viewer sees on the screen, where the red, green and blue images are rapidly sequenced on the screen, fast enough so the viewer integrated these as a full color image.

FIG. 6 shows the polarizing layer made up of six segments which match in shape and size to the color segments of the color wheel. There are three segments of polarizing material for the left-eye view, and three segments of polarizing material for the right-eye view in crossed polarized orientation.

The segments are aligned symmetrically around the axis of rotation, such that when the wheel rotates and light passes through each segment, the same polarizing orientation exist for each of the three polarizing segments for their respective left-eye and right eye views. Exploded views of each segment indicate the polarizing orientations. If there are “white” segments in the color wheel, each alternate “white” segment of the color wheel is overlaid by polarizing material of alternating polarizing orientation.

FIG. 7 shows the combination of the color wheel layer to the polarizing layer, such that the segments of each layer superimpose to create a two layer “sandwiched” color/polarizing wheel. One RGB group is aligned with the polarizing orientation for the left-eye view, and the second RGB group is aligned with the polarizing orientation for the right-eye view

### DETAILED DESCRIPTION

A single-chip Spatial Light Modulator (such as a DMD: Digital Micromirror Device, a DLP technology by Texas Instruments) based TV or projector using a color wheel to render red, green and blue primary colors separately onto the screen as sub-frames [FIGS. 2, 3, 4], has at a very fast sub-frame interleave.

The DMD will be used as an example for this invention, even though other technologies such as GLV (Grating Light Valve) may be substituted for the Spatial Light Modulator.

The DMD is a device used in which each pixel of the sub-frame is rendered by an associated mirror having two states, “on” and “off”. The “on” and “off” time is controlled by pulse-width modulation, created by support circuitry of the DMD, whereby the intensity or brightness of the pixel is proportional to the averaged “on” time, over all the sub-frames for its associated primary color within each frame of video.

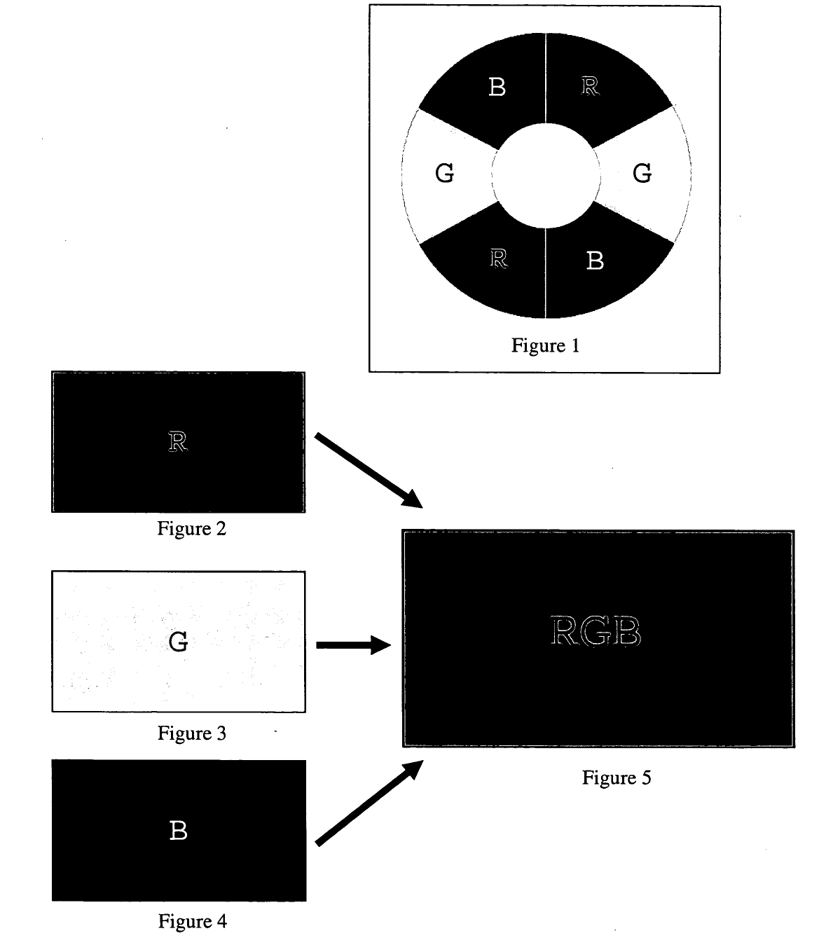

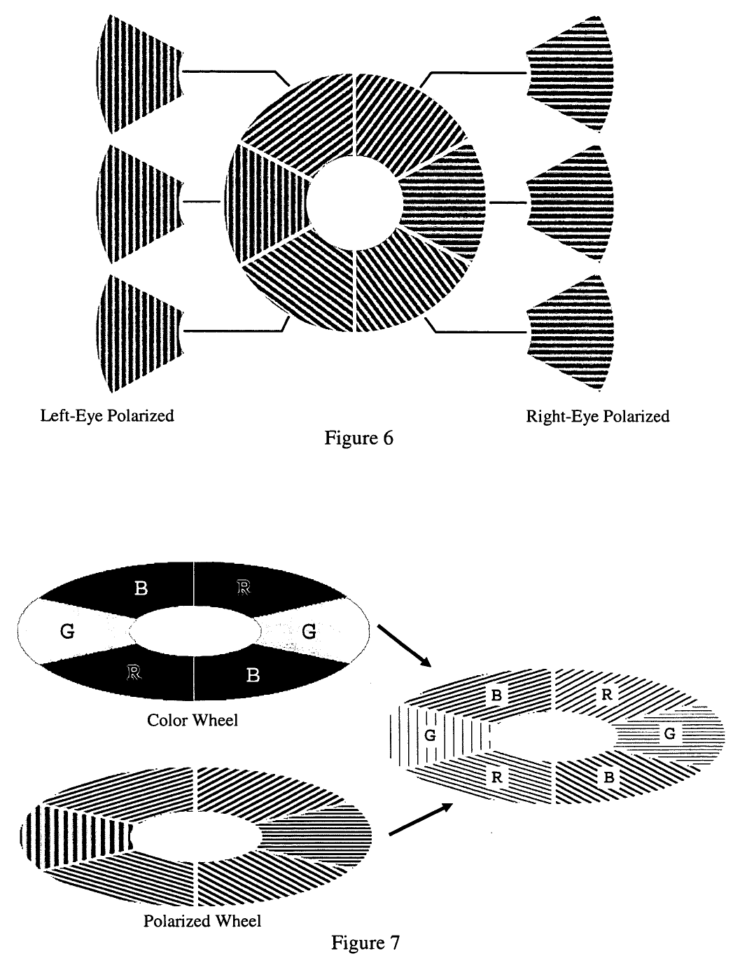

The color wheel [FIG. 1] is a opto-mechanical assembly that contains multiple pieces of primary colored arc segments mounted to a motor, which rotates at a multiple of the frame-rate. White light is aimed at the color wheel, which causes red, green or blue light to be filtered through. These colors are then projected onto the DMD chip, which modulates the intensities for each pixel based on the brightness for each color, and requires three sub-frames per frame of video [FIGS. 2, 3, 4], to create a combined full color frame on the screen [FIG. 5]

To prevent a viewer from observing color sequencing of the sub-frames, the color wheel is rotated at a multiple of the frame-rate, typically four to six times. The color wheel also has a number of RGB groups, typically two or an even number, to accommodate varying frame rates, typically thirty or sixty frames per second while maintaining a constant rotational speed, as well as to reduce the rotational speed.

It is therefore common for a DMD based TV, displaying 30 fps video to generate:
(30 fps)×(3 RGB_Arcs)×(2 RGB groups per color wheel)×(4 rotates)=720 sub-frames per second

For stereoscopic applications, the RGB groups are divided evenly between “left-eye” and “right-eye” assignments, so from the above calculation, 360 sub-frames per second will be presented to each eye. In other words 120 full-color RGB frames will be presented to each eye.

[FIG. 6] shows the polarizing layer made up of six arc segments, also shown in exploded view to indicate the polarizing orientation of each arc segment. These polarizing arc segments match in shape and size to the color segments of the color wheel. Three adjacent arc segments of polarizing material are for the left-eye view, and the next three adjacent arc segments of polarizing material are for the right-eye view in crossed polarized orientation.

All the polarizing arc segments are combined to create a single layer of polarizing material. The arc segments are aligned symmetrically around the axis of rotation, such that when the wheel rotates and light passes through each adjacent arc segment, the same polarizing orientation exists for each of the three polarizing arc segments for their respective left-eye and right eye views, as shown by the direction of shading lines in [FIG. 6]

The polarizing orientation for each eye needs to be cross-polarized. For one embodiment of this invention where the polarizing material is linearly polarized, the second orientation will be perpendicular to the first orientation. For another embodiment of this invention where the polarizing material is circularly polarized, the second orientation will be the reverse direction to the first orientation.

The polarizing layer [FIG. 6] is combined with the color wheel layer [FIG. 1], such that the arc segments of each layer are superimposed, and a two layer “sandwiched” color/polarizing wheel is thereby created. One RGB group of adjacent RGB arc segments is aligned with the polarizing orientation for the left-eye view, and the second RGB group is aligned with the polarizing orientation for the right-eye view as shown in [FIG. 7].

The color/polarizing wheel described in this invention, in conjunction with the DMD, becomes a shutter for rendering the primary color images on the screen as well as a shutter for rendering polarized light of these colors on the screen.

Polarized primary-color sub-frames are therefore rendered on the screen at a multiple of the frame rate.

The following table represents a typical example the sequence of light filtered through the color/polarizing wheel, as it rotates four times during a single frame of video, and assumes a six-segment color wheel, thereby producing 24 sub-frames. This example is the typical speed of a DMD based TV or projector:

| | | | |
|---|---|---|---|
| 1) 1st rotation | Red | Segment R1 | Left-Eye |
| | | | Polarized |
| 2) 1st rotation | Green | Segment G1 | Left-Eye |
| | | | Polarized |
| 3) 1st rotation | Blue | Segment B1 | Left-Eye |
| | | | Polarized |
| 4) 1st rotation | Red | Segment R2 | Right-Eye |
| | | | Polarized |
| 5) 1st rotation | Green | Segment G2 | Right-Eye |
| | | | Polarized |
| 6) 1st rotation | Blue | Segment B2 | Right-Eye |
| | | | Polarized |
| 7) 2nd rotation | Red | Segment R1 | Left-Eye |
| | | | Polarized |
| 8) 2nd rotation | Green | Segment G1 | Left-Eye |
| | | | Polarized |
| 9) 2nd rotation | Blue | Segment B1 | Left-Eye |
| | | | Polarized |
| 10) 2nd rotation | Red | Segment R2 | Right-Eye |
| | | | Polarized |
| 11) 2nd rotation | Green | Segment G2 | Right-Eye |
| | | | Polarized |
| 12) 2nd rotation | Blue | Segment B2 | Right-Eye |
| | | | Polarized |
| 13) 3rd rotation | Red | Segment R1 | Left-Eye |
| | | | Polarized |
| 14) 3rd rotation | Green | Segment G1 | Left-Eye |
| | | | Polarized |
| 15) 3rd rotation | Blue | Segment B1 | Left-Eye |
| | | | Polarized |
| 16) 3rd rotation | Red | Segment R2 | Right-Eye |
| | | | Polarized |
| 17) 3rd rotation | Green | Segment G2 | Right-Eye |
| | | | Polarized |
| 18) 3rd rotation | Blue | Segment B2 | Right-Eye |
| | | | Polarized |
| 19) 4th rotation | Red | Segment R1 | Left-Eye |
| | | | Polarized |
| 20) 4th rotation | Green | Segment G1 | Left-Eye |
| | | | Polarized |
| 21) 4th rotation | Blue | Segment B1 | Left-Eye |
| | | | Polarized |
| 22) 4th rotation | Red | Segment R2 | Right-Eye |
| | | | Polarized |
| 23) 4th rotation | Green | Segment G2 | Right-Eye |
| | | | Polarized |
| 24) 4th rotation | Blue | Segment B2 | Right-Eye |
| | | | Polarized |

Because the color wheel in this tabulated example rotates four times per frame of video, and the color wheel consists of two RGB groups, the resultant rendering frame rate for each eye is 120 frames per second, assuming a video input frame rate of 30 frames per second.

This multi-sub-frame rendering is already being done by the DMD and support chips for regular “2D” video. This invention uses this existing sub-frame interleaving principle now to render stereoscopic “3D”, without the need for shutter glasses. Passive polarized glasses are all that are required.

The rendering of the RGB color sequence is synchronized with the DMD using the DMD support circuitry. This synchronizes the rotation of the color wheel to the sub-frames rendered into the DMD for each primary color as the associated color segment passes over the beam of white light to be filtered, and ultimately synchronized to the incoming video signal.

The DMD support circuitry typically generates the multiple sub-frames required, from each full frame of video residing in an associated memory buffer.

In one embodiment of this invention, this memory buffer is doubled in size, such that the capacity can fit two frames of video for the “left-eye” and “right-eye” stereoscopic pair of frames, and bank switched when reading each alternating RGB group. The memory will need to be loaded in a FIFO arrangement where the input data bus will have double the data rate.

In another embodiment of this invention, where there is sufficient memory capacity to hold two frames of video, the pulse-width-modulation signals sent to the DMD are assigned in groups separately for “left-eye” and “right-eye” sub frames, instead of spread evenly across each sub-frame for each associated color. This technique would lose one least-significant bit of each color bit depth. A typical DMD has the capacity to render ten bits per color per pixel, so this would become 9 bits. This can be performed by firmware in the DMD support circuitry.

In another embodiment of this invention, the support circuitry of the DMD may store in memory, a higher resolution image frame, which is spatially multiplexed between two smaller (lower resolution) frames consisting of the “left-eye” and the “right-eye” frame stereo-pair. The input to the DMD will then be presented with the lower resolution sub-frames consisting of “left-eye” and “right-eye” images, consistent with this invention, except taking advantage of memory capable of higher resolution, and also ensuring the stereo pair is maintained together as a pair, and effectively as a single tiled frame holding the stereo pair. This enhanced embodiment also has the benefit of allowing a single higher resolution tiled frame to be encoded as a single video stream, for transport or storage.

In another embodiment of this invention, there are two sets of identical DMD support circuitry, each with its own associated memory buffer. One set is dedicated to the “left-eye” view, and the other set is dedicated to the “right-eye” view. These two sets of support circuitry is then multiplexed to a single DMD device, and synchronized to the incoming stereoscopic image streams, which need to be gen-locked together.

The light path this DMD based stereoscopic display, starts out as a beam of white light, typically concentrated down a “light-pipe”, which shines onto the spinning color/polarizing wheel, which filters the primary-color and polarization orientation of the light as it passes through. This light now impinges upon the surface of the DMD, whose surface is covered by an array of vibrating mirrors controlled by pulse-width modulators. The light reflected off the DMD then goes through a series of lenses to magnify the image to the desired size required on the surface of a screen.

Whether the screen is “rear-projection” or “front-projection”, it will need to be made of a material that does not alter the polarizing properties of light shining through it or onto it, respectively.

The screen is viewed as a regular TV, and when “Stereoscopic 3D” mode is enabled, the viewer needs to wear a pair of passive cross-polarized glasses, which separates the polarized light using polarizing filters, so that each eye sees its respective “left-eye” and “right-eye” view, which matches the polarization generated by the color wheel.

This invention takes advantage of the existing capabilities of specific TVs and projectors, to produce a good quality Stereoscopic 3D display, at a low cost.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1) A method of producing stereoscopic 3D television using the spinning color wheel of a TV or projector that uses a single spatial light modulator, such as a DMD.

2) The method of claim 1, by combining polarizing material as an extra layer to the color segments of the color wheel.

3) The method of claim 2, in which the polarizing material is used as a Linear or Circular polarizing filter of light passing through.

4) The method of claim 2, in which the single layer of color segments of the color wheel is “sandwiched” with a single layer of polarizing material, creating a double layer color/polarizing wheel.

5) The method of claim 2, in which the polarizing material is created as segments, which superimpose and match the shapes of each color segment of the color wheel.

6) The method of claim 5, in which three adjoining segments of the color wheel, normally red, green and blue, are considered a RGB group, and the color wheel consists of an even number of RGB groups. The polarizing layer superimposed over the first RGB group is assigned for “left-eye” view, and the polarizing layer superimposed over the next RGB group is assigned for “right-eye” view. If the color wheel consists of more than 2 RGB groups, then the polarizing layer will toggle between assignments for “left-eye” and “right-eye” views, until all the RGB groups are covered.

7) The method of claim 6, in which the polarizing orientation is maintained during each RGB group, so that when the color/polarizing wheel is rotated, light passing through each segment within an RGB group will have the same polarizing orientation.

8) The method of claim 6, in which the polarizing material for the “left-eye” view is linearly polarized in one orientation, and the polarizing material for the “right-eye” view is linearly polarized in a cross-polarized, or perpendicular orientation. The light source being non-polarized.

9) The method of claim 6, in which the polarizing material for the “left-eye” view is circularly polarized in one orientation, and the polarizing material for the “right-eye” view is circularly polarized in a cross-polarized, or reverse orientation. The light source is initially linearly polarized.

10) The color/polarizing wheel in this invention becomes a shutter for rendering the primary color images on the screen as well as a shutter for rendering polarized light of these colors on the screen.

11) The method of claim 10, using the support circuitry of the Spatial Light Modulator to accept “left-eye” and “right-eye” digitized imagery, as sub frames.

12) The method of claim 11, in which color images are rendered onto the screen sub-frame color interleaved, and sub-frame polarized-orientation interleaved.

13) The method for displaying on a single display surface, two different images, each cross polarized, onto a single screen, in which the screen does not alter the polarized nature of the light projected onto it.

14) The method of claim 13, of viewing the stereoscopic rendering, in which a viewer, wearing passive cross-polarized glasses, views the stereoscopic imagery.

15) The compatibility of this invention with color wheels that include a “white” segment, in which case in all other embodiments of this invention referring to RGB groups or sequences, can be substituted with RGBW groups or sequences, respectively, where each alternate “white” segment of the color wheel is overlaid by polarizing material of alternating polarizing orientation.
